(19) United States
(12) Patent Application Publication
(10) Pub. No.: US 2013/0122457 A1
(43) Pub. Date: May 16, 2013

(54) DENTAL TREATMENT DEVICE

(71) Applicant: Burghardt Krebber, Landsberg/Lech (DE)

(72) Inventor: Burghardt Krebber, Landsberg/Lech (DE)

(21) Appl. No.: 13/738,615

(22) Filed: Jan. 10, 2013

Related U.S. Application Data
(63) Continuation-in-part of application No. 12/593,284, filed on Mar. 22, 2010.

(30) Foreign Application Priority Data
Mar. 28, 2007 (EP) EP07006420.9
May 23, 2007 (EP) EP07010242.1
Nov. 29, 2007 (EP) EP07023185.7

(51) Int. Cl. A61C 19/06

(52) U.S. Cl. CPC A61C 19/063
USPC 433/82

(57) ABSTRACT

A device for treating a dental tissue comprising (a) an ozone generator for generating an ozone containing gas, (b) a first pump in fluid flow communication with the ozone generator for generating a flow of ozone containing gas, (c) an applicator for multiple teeth having a surface suitable for forming with the hard and soft dental tissue of multiple teeth to be treated (d) a treatment chamber having an inlet orifice in fluid flow communication with the ozone generator and the first pump and having an outlet orifice, and (e) a second pump in fluid flow communication with the outlet orifice of the applicator for removing gas from the treatment chamber. The second pump has a second throughput and the first pump has a first throughput whereby the ratio of the second throughput to the first throughput is at least 1.5:1.

### CROSS-REFERENCE To RELATED APPLICATIONS

This application is a continuation-in-part of U.S. application Ser. No. 12/593,284, filed Mar. 22, 2010, which was in turn a National Stage application of International Patent Application Number PCT/EP2008/002517, filed on Mar. 28, 2008, which claims the benefit of and priority to European Patent Application Number 07006420.9, filed Mar. 28, 2007; European Patent Application Number 07010242.1, filed on May 23, 2007; and European Patent Application Number 07023185.7, filed on Nov. 29, 2007, the contents of all of which are incorporated by reference herein in their entirety.

### BACKGROUND

1. Field

The present disclosure relates to a device for treating dental hard and soft tissues with a flow of ozone containing gas. The present disclosure also relates to an applicator for such a device. Moreover, the present disclosure further relates to a method of treatment of dental hard and soft tissues of a patient by applying a continuous pulsing flow of ozone containing gas. Finally, the present disclosure relates to a method of treatment of a dental tissue of a patient by applying a continuous flow of ozone containing gas.

2. General Background

Decay of hard dental tissue is caused by microorganisms propagating in the vicinity of the hard dental tissue. Dental caries is based on the acid dissolution of enamel, dentine or cementum as a consequence of the metabolism of microorganisms living within deposits on the teeth known as plaque. Moreover, infections of soft dental tissue are caused by microorganisms propagating in the soft dental tissue.

In order to interrupt the progress of hard dental tissue decay, the decayed hard dental tissue including the microorganisms are commonly removed by a drilling treatment and the cavities thereby formed are sealed and filled with a restorative material. Dental treatment by drilling a tooth causes significant discomfort and anxiety to the patient. Moreover, the drilling treatment not only removes decayed dental tissue, but also healthy dental tissue. In addition, materials used for restorations may be problematic in that e.g. gold and ceramic are expensive and present a technical challenge for the practitioner whereas amalgam is potentially toxic and may cause allergic reactions. Therefore, alternative methods for the control of bacterial growth on and inside hard and soft dental tissue are desired.

In this context, the application of ozone to dental tissue was considered. W002078644 suggests the use of ozone in the treatment of dental and oral conditions. Ozone is a strongly oxidizing gas having bactericidal effects. However, ozone is also a highly toxic gas which may lead to severe poisoning when inhaled by a patient. Therefore, the application of ozone to hard and soft dental issue in the mouth of the patient requires applicator devices which are suitable for delivering a sufficiently high ozone concentration to the decaying dental tissue while at the same time avoiding contamination of the patient.

A dental applicator is known (OzonyTron commercially available from Mymed, Germany and DE 20 2005 012 281 U1) which generates small amounts of ozone gas in a glass nozzle to be positioned in dose proximity to the dental tissue to be treated. The ozone diffuses from an orifice of the nozzle so that a concentration gradient is formed wherein a bactericidally effective dose of ozone can only be expected within a distance of less than 3 mm from the orifice. According to this technology, a flow of ozone containing gas is not used. Given that only minor amounts of ozone are generated by the device and given that the treatment time does not exceed about 40 seconds, the risk of a contamination of the patient with ozone is believed to be acceptable despite the use of an open system. However, ozone is inevitably inhaled by the patient since means for eliminating gaseous ozone from the mouth of the patient are not provided. Furthermore, micro currents due to the ozone generation in a plasma inside the applicator nozzle placed in dose proximity to the dental issue may be felt by the patient as an uncomfortable side effect. Finally, since the nozzle is made of a delicate glass structure, the device may break during the application of ozone.

A further dental applicator is known which uses a silicon cup placed on a dental surface to be treated. The silicon cup is connected to a vacuum pump for creating a vacuum inside a treatment chamber defined by the sleeve and the dental surface to be treated. The silicon cup forms a tight seal when a vacuum is applied. As soon as a predetermined vacuum is established, the device generates ozone and releases small amounts inside the treatment chamber for treatment of the dental surface. Ozone generation is discontinued when the pressure inside the silicon cup rises, indicating a leakage of the seal. Therefore, the performance of the applicator depends on the quality of the tight seal formed between the silicon cup and the dental surface to be treated. Given that decaying dental surfaces may not be able to form a tight seal due to the complicated surface topology, the tight seal may often not be reliably formed so that an application of ozone does not efficiently take place. As a remedy, a range of different silicone cups are provided which lead to further complications of the procedure.

Known dental applicators are not capable of administering ozone over an extended period of time so that a significant amount of ozone may be safely and efficiently delivered to decaying dental tissue in the treatment of deep caries, gingivitis and parodontitis.

Moreover, known dental applicators are not capable of treating a large dental surface over an extended period of time without the risk of contamination of the patient.

Finally, known dental applicators are not able of administering ozone over an extended period of time to soft tissue and saliva so that a significant amount of ozone may be safely and efficiently delivered and reach infected soft dental tissue gingivitis parodontitis and by diffusion in the treatment of granuloma.

### SUMMARY

In one embodiment of the present disclosure, a device for safe and efficient treatment of hard and soft dental tissues is provided.

In another embodiment of the present disclosure, a device for treating hard and soft dental tissues with a flow of ozone over an extended period of time with a device which may be easily hand led and does not cause discomfort to the patient is provided.

In yet another embodiment of the present disclosure, a device for treating a large surface of hard and soft dental tissues or a dental surface, which is difficult to access over an extended period of time, is provided.

In yet another embodiment of the present disclosure, a device for treating dental hard and soft tissues with an ozone containing gas is provided where the device comprises one or more of the following: (a) an ozone generator for generating an ozone containing gas, (b) a first pump being in fluid flow communication with the ozone generator for generating a flow of ozone containing gas, (c) an applicator having a surface suitable for forming a chamber with the dental tissue and gums to be treated and inner wall of the applicator, (d) a treatment chamber having at least one inlet orifice being in fluid flow communication with the ozone generator and the first pump and having at least one outlet orifice, and (e) a second pump being in fluid flow communication with the outlet orifice of the applicator for removing gas from the treatment chamber, whereby said second pump has a second throughput and the first pump has a first throughput whereby the ratio of the second throughput to the first throughput is at least 1.5:1.

At least one aspect of the present disclosure is based on the recognition that dental caries, parodontitis gingivitis and granuloma (pus at the teeth roots or in gums) and more may be treated by exposing a dental tissue suffering from undesired bacterial growth to a continuous flow of ozone containing gas, preferably a continuous pulsing flow of ozone containing gas. In case of deep dental caries, parodontitis, gingivitis and granuloma, ozone may diffuse across plaque or hard and soft tissue before reaching the microorganisms.

Moreover, the present disclosure is based, at least in part, on the recognition that the success of treating the space between the teeth, the root canals, and the cavities treatment may be significantly increased when the space between the teeth, the root canals, and the cavities is treated with ozone containing gas.

The present disclosure is further based on, at least in part, the recognition that a continuous flow of ozone may be applied to a dental surface over an extended period of time without the risk of contamination of the patient when a combination of two pumps is used so that a first pump having a first throughput introduces an ozone containing gas into a treating chamber whereby a second pump having a higher throughput removes ozone containing gas from the treating chamber including air which has entered into the treating chamber through not tight portions of the seal between the applicator and the dental tissue or the gums. The dental applicator forming the treating chamber is normally a prefabricated (by an injection moulding machine) applicator for repeated applications of ozone in the prevention and/or treatment of dental caries, gingivitis, parodontitis and granuloma or any infection in the gums.

In one aspect of the at least one embodiment of the present disclosure, a special dental applicator may be adapted to the dentition of a specific patient. The present disclosure uses a partial pressure of ozone in the ozone containing gas which is in a range previously unattainable when applying a vacuum and too dangerous to use in an open system. The high partial pressure of ozone in the continuous, preferably pulsing, flow of oxygen as provided by the device of the present disclosure forces the ozone deep into the dental tissue and gums whereby an efficient treatment of deep caries, gingivitis, parodontitis and granuloma or any infection in the gums is possible without the need for drilling treatment or surgery. Accordingly it is possible to efficiently interrupt infection and decay of dental tissue or gums due to bacteria eliminating while at the same time avoiding the pain and anxiety associated with a drilling treatment and surgery as well as avoiding unnecessary loss of healthy dental tissue or entire teeth.

In one aspect of at least one embodiment of the present disclosure, an applicator for a device according to at least one embodiment of the present disclosure is provided.

### DRAWINGS

The above-mentioned features and objects of the present disclosure will become more apparent with reference to the following description taken in conjunction with the accompanying drawings wherein like reference numerals denote like elements and in which:

FIG. 1 is a schematic representation of an embodiment of the device according to at least one embodiment of the present disclosure;

FIG. 2 is a schematic partial representation of an alternative embodiment of the device;

FIG. 3 is an elevational view of a preferred embodiment of the invention illustrating the arrangement of the components of FIG. 1, the moisture trap being eliminated for convenience of illustration, the housing shown in the open position;

FIG. 4 is a view similar to FIG. 1 showing the housing in a closed position;

FIG. 5 is a perspective view of the housing alone FIGS. 3 and 4 shown in a closed position; and

FIG. 6 is an elevational view of the hose and mouthpiece of the applicator.

### DETAILED DESCRIPTION

The present disclosure provides a device for treating a dental tissue and gums with a continuous flow of ozone containing gas, preferably a continuous pulsing flow of ozone containing gas. The gas may be air having an oxygen content in the range of from 20 to 99 percent by volume. Accordingly, pure air may preferably be used for the ozone generator or a mixture comprising air and additional pure oxygen gas. The dental tissue to be treated includes hard and soft tissues. Hard tissue includes dentin and enamel as well as any restoration permanently provided on the dentin or enamel. Soft tissue includes any tissue in the mouth which is not hard tissue including gums, the inside of pockets formed by the soft tissue. Treatment of dental tissue within the meaning of the present disclosure includes the exposure of dental surfaces to ozone molecules in a concentration suitable for controlling bacterial growth. Preferably, the treatment also includes the penetration of the dental surface by the ozone so that bacterial growth below the surface of the dental tissue and the gums may be controlled. Since anaerobic bacteria propagate in an environment where oxygen is not available, the treatment according to the present disclosure may be directed to providing an exposure of such bacteria even in such anaerobic environments. For this purpose, the dental tissue is exposed to a high ozone partial pressure over a prolonged period of time. Accordingly, it is possible to not only treat and prevent caries and other infections to the surface, but also to control bacteria causing caries in layers below the dental and gum tissue surfaces.

The device according to at least one embodiment of the present disclosure comprises an ozone generator for generating an ozone containing gas. The ozone generator may be a conventional ozone generator using an electric discharge for cleaving oxygen molecules in a plasma. Preferably, the ozone generator allows controlling the rate of ozone generation in order to adjust the ozone concentration in the ozone containing gas. The ozone containing gas generated by the ozone generator preferably has an ozone concentration of from 50 to 20,000 ppm, more preferably an ozone concentration of from 100 to 10,000 ppm. For safety reasons, the ozone generator is preferably arranged in series with the first and the second pump so that the ozone generator may only be activated when the pumps are running so that a flow of gas is present which prevents the ozone from being discharged from the ozone generator in an uncontrolled manner.

The device according to at least one embodiment of the present disclosure further comprises a first pump being in fluid flow communication with the ozone generator for generating a flow of ozone containing gas. In one aspect of at least one embodiment, the first pump (1) is arranged so as to discharge a stream of gas, such as air, into the ozone generator for providing a continuous flow of ozone containing gas downstream from the first pump. In another aspect of at least one embodiment of the present disclosure, the first pump has a first throughput.

Moreover, the first pump has a first pumping speed. Preferably, the first pump has a pumping speed in the range of from 1 to 10 l/min, more preferably from 2 to 6 l/min.

In one aspect of at least one embodiment of the present disclosure, the device further comprises an applicator available in different sizes having a surface suitable for forming with the dental tissue and the gums to be treated a chamber having at least one inlet orifice being in fluid flow communication with the ozone generator and the first pump and having at least one outlet orifice, being in fluid flow communication with the second pump.

In at least one embodiment of the present disclosure, an applicator prefabricated by injection moulding machines, available in different sizes, is provided. It is to be used for the complete row of teeth, preferably both for the upper and lower jaw. The applicator may be U-shaped. The applicator may be designed to fit to nearly all patients. In one aspect of at least one embodiment of the present disclosure, in the applicator, the ozone containing gas is led through an orifice to the front teeth. In another aspect of at least one embodiment of the present disclosure, the ozone flows right and left along the teeth in the direction of the ends of the applicator. In yet another aspect of at least one embodiment of the present disclosure, a second orifice in the front side of the applicator is connected to invisible integrated ducts in the applicator wall. These ducts may lead to the right and left ends of the applicator. At the ends of the applicator these ducts are open to the inside of the applicator from where the gas with remaining ozone is sucked out of the applicator. Due to the higher outgoing suction power compared to the incoming pressure, no ozone gets into the patient's mouth. Hence, no ozone can be inhaled by the patient. The applicator should consist of sterilizable material.

In another aspect of at least one embodiment of the present disclosure, the applicator according to the present disclosure is a custom made applicator which is adapted to the teeth of a specific patient

Moreover, the device of at least one embodiment of the present disclosure may further comprise a moisture trapping means which is in fluid communication with the outlet orifice of the applicator for removing gas from the treatment chamber. The moisture trapping means may be a container were the input orifice is separated from the output orifice so that the moisture remains in the container and the moisture is separated from the ozone containing gas.

Alternatively, the container may contain a drying agent or a cold surface for eliminating any water vapour remaining in the flow of ozone containing gas discharged from the treatment chamber before entering the second pump.

In another aspect of at least one embodiment of the present disclosure, the device further comprises a second pump being in fluid flow communication with the outlet of the moisture trapping means. In yet another aspect of at least one embodiment of the present disclosure, the second pump has a second throughput. The ratio of the second throughput to the first throughput is at least 1.5:1, preferably 2:1. Moreover, the second pump preferably has a pumping speed in the range of from 1.5 to 15 l/min. In yet another aspect of at least one embodiment of the present disclosure, the activation of the second pump is a necessary condition for the possibility of activating the ozone generator so that the contamination of the patient may be excluded.

In yet another aspect of at least one embodiment of the present disclosure, the device further comprises an ozone scavenging means which is in fluid communication with the outlet orifice of the second pump. The scavenging means may contain a reducing agent which eliminates any ozone remaining in the flow of ozone containing gas discharged from the treatment chamber.

In another aspect of at least one embodiment of the present disclosure, the device may further comprise one or more control means for controlling the throughput of the first and/or second pump. The one or more control means of the device of the present disclosure may periodically change the ratio of the first throughput to the second throughput so that the speed of the continuous flow and consequently the pressure of ozone containing gas periodically changes in the treatment chamber. For example, during the ozone treatment, the vacuum of the applicator may be interrupted for 0.3 seconds every two seconds. Furthermore, the one or more control means may periodically reduce the throughput followed by an increase of the throughput of the pump. The reduction and increase of the throughput may occur with a frequency of from 1 to 200 cycles per minutes, preferably from 20 to 40 cycles, or, in another embodiment, 30 cycles per minute. The periodical changes of the speed of the continuous flow of ozone containing gas in the treatment chamber by one or more control means improves the contact of dental surfaces in the treatment chamber with ozone and thereby increases the efficiency of the treatment. So the ozone can penetrate the space between the teeth, the root canals, the cavities and more.

In yet another embodiment of the present disclosure, a device comprising the ozone generator, the first pump the second pump, the scavenging means and the control means may be provided in a housing. At the front panel side of the housing there is a hollow forming lid, which is connected to the housing by a hinge. The lid is easy to open and close as a reversibly sealable hollow chamber. During the treatment of the patient the lid is open and so it gives access to front panel, where all required controls are installed.

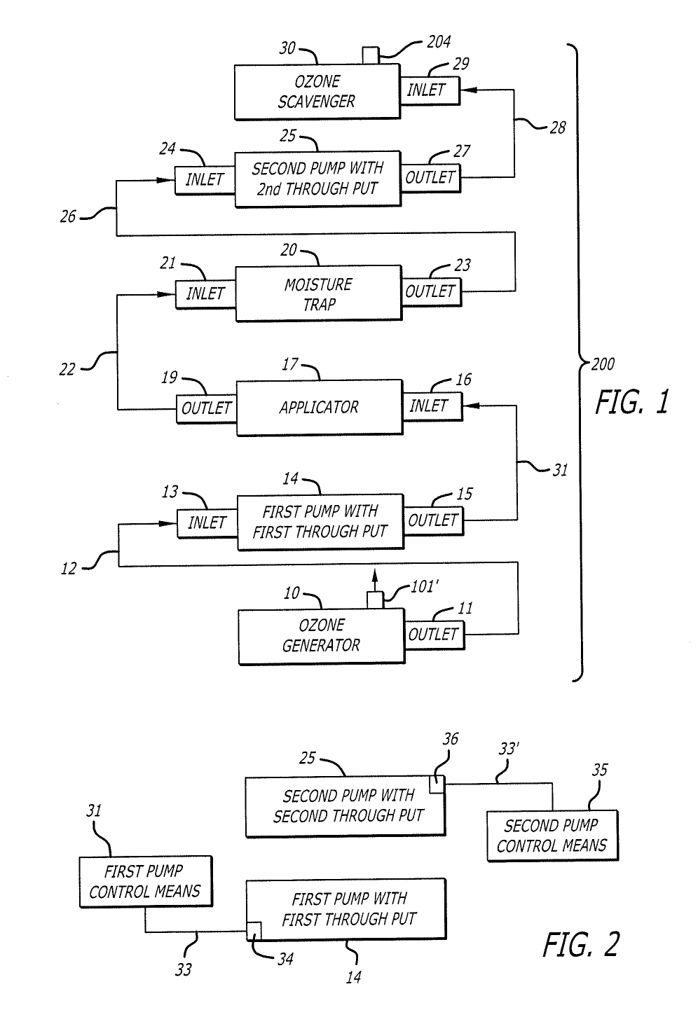

FIG. 1 shows a schematic representation of a preferred embodiment of the device according to one embodiment of the present disclosure. A treatment chamber 200 is provided including an ozone generator 10 having an outlet 11 fluidly communicating via fluid line 12 with the inlet 13 of a first pump 14 having a throughput therein. The first pump 14 and the ozone generator 10 may be combined into a single device for providing a flow of ozone gas out of the first pump outlet 15 via line 31 to the inlet 16 of applicator 17.

Thus, the ozone containing gas generated by ozone generator 10 and fed to first pump 14 is pumped out of pump outlet 15 via fluid line 31 to inlet 16 of dental applicator 17. Fluid from applicator 17 is pumped out of outlet 19 to inlet 21 of a moisture trap 20 via fluid line 22. This dries the flow of the ozone containing gas from the applicator 17.

Moisture trap 20 has an outlet 23 in fluid flow communication with the inlet 24 of a second pump 25 having a throughput therein via fluid flow line 26. The outlet 27 of the second pump 25, which is a suction pump for applicator 17, is in fluid flow communication via its outlet 27 and fluid flow line 28 with the inlet 29 of an ozone scavenger 30 for eliminating excess ozone present in the flow of the gas. Scavenger 30 has an outlet 204 for venting off any gas into the atmosphere that is not destroyed in scavenger 30.

The applicator 17 includes therein a hose assembly comprising an inlet hose 201 and an outlet hose 202 coupled to a mouthpiece 203 for distributing ozone to the patient. Ozone is thus introduced into the mouth through hose 201 (FIG. 6) via mouthpiece 203 and is distributed throughout the upper and lower teeth row of the patient. Ozone is removed through hose 202.

During the ozone treatment, the vacuum device may be interrupted for 0.3 seconds every two seconds. This causes a temporary overpressure which makes ozone enter into even the smallest interdental spaces, gums pockets, cavities and root canals. This process is so simple that the patient needs few assistance. Preventive treatment should be conducted every 6 months and should last at least ten minutes.

The applicator 17 may include a Start/Stop button, which starts a preprogrammed treatment cycle which stops automatically after 10 minutes. Additionally, the cycle may be stopped manually at any time.

Since the dental tissue of the patient in the oral cavity is to be treated with the ozone containing gas, the dental tissue must be exposed to the ozone containing gas. On the other hand, ozone is a highly toxic gas which must be prevented from being inhaled by the patient. Accordingly, the surface of the dental tissue to be treated forms a portion of the wall of the treatment. The inner surface of the mouthpiece 202 forms the remaining portion of the treatment. The mouthpiece 202 is preferably made of flexible material so that a tight seal between the dental tissue and the mouthpiece 202 may be formed and so that the treatment which is formed when the mouthpiece 202 is in the oral cavity, retains the ozone.

Moreover, the mouthpiece essentially has an inner surface which is parallel to but distanced from the dental tissue to be treated and which forms a seal with the dental tissue at the edge of the surface of the dental tissue to be treated. Accordingly, a space is formed which extends over the surface of the dental tissue to be treated. The orifices should be provided such that a flow of gas is created when the ozone containing gas enters and exits the hose or tubing 201, which flow covers as much of the surface of the dental tissue to be treated. A suitable applicator may be formed by the technique described herein.

Thus, as seen in FIG. 2, a first pump control means 31 is coupled to a valve 34 via control line 33 which valve 34 is in fluid communication with first pump 14. A second pump control means 35 is coupled via control line 33¹ to a valve 36 in fluid communication with second pump 25. In this manner, the first pump control means 31 can be used to periodically change the ratio of the first pump throughput by selectively opening and closing valve 34. The second control means 35 can change the throughput of pump 25 via control of valve 36.

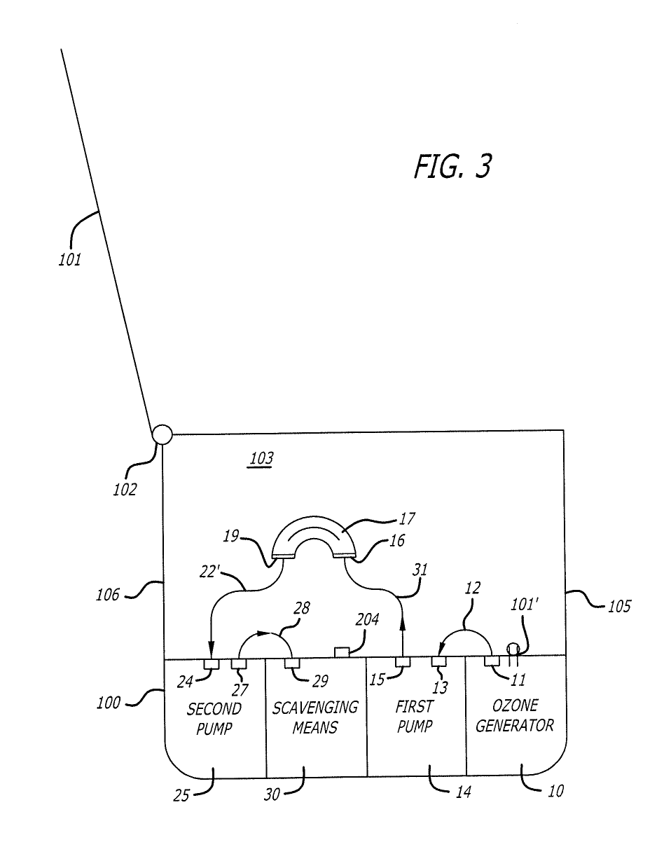

Thus, valve 101¹ in FIG. 3 is closed during the treatment process so that ozone gas cannot be released to the atmosphere when lid 101 is open during the treatment of the patient. Scavenged gas from scavenger 30 is emitted into the atmosphere out of outlet 204.

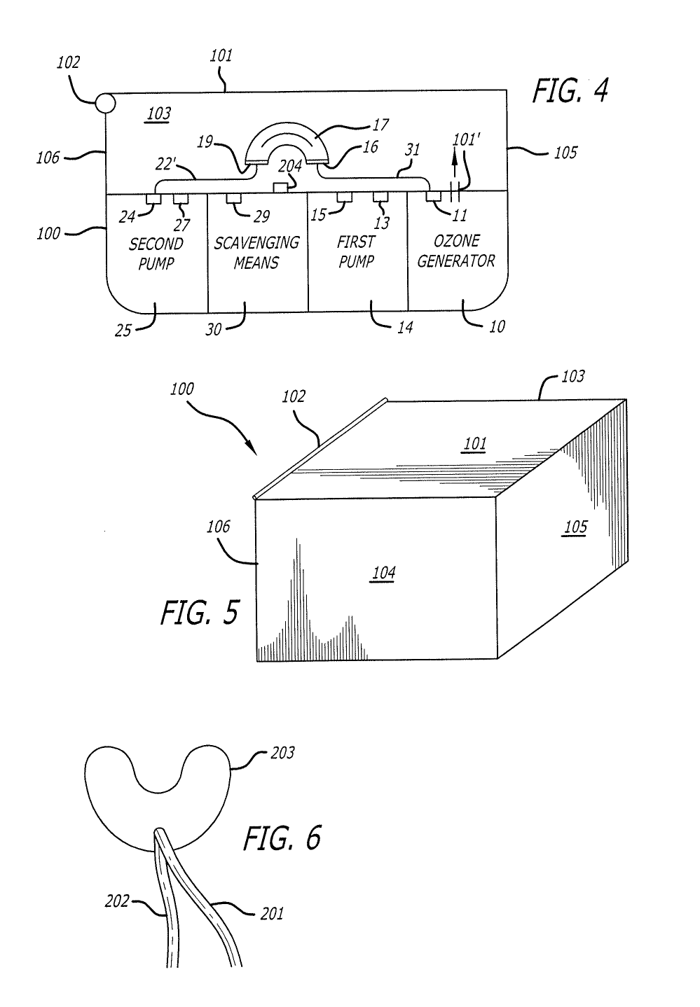

The pumps, ozone scavenger and ozone generator may be mounted in a housing 100 (FIG. 3) having a lid 101 hinged thereto at hinge 102 for selectively opening and closing housing 100 thus exposing the interior to the environment or atmosphere. Housing 100 has a back wall 103, (side walls 105, 106—front wall 104—see FIG. 5—not shown in FIGS. 3 and 4).

Thus, as seen in FIG. 3, the outlet 11 of the ozone generator 10 is coupled via fluid line 12 to the inlet 13 of first pump 14. The outlet 15 of first pump 14 is coupled via fluid line 31 to the inlet 16 of the applicator 17. The outlet 19 of the applicator 17 is coupled via fluid line 22¹ (the moisture trap 20 not shown in FIG. 3) to the inlet 24 of second pump 25. The gas from second pump 25 goes out outlet 27 into inlet 29 of the scavenging means 30 via line 28. The position of the lid 101 and housing 100 in FIG. 3 illustrates the position of the parts for the treatment process.

When it is desired to sterilize the parts, lid 101 is closed as shown in FIG. 4 providing a reversibly sealable chamber in fluid communication with the ozone generator, the inner walls of the chamber at least partially comprised of surfaces of the device that were exposed to the environment during use of the device for treating a dental tissue as in FIG. 3. Valve outlet 101¹ is opened and ozone gas is released into the sealed chamber shown in FIG. 4 and the equipment therein is sterilized by the released ozone gas. The closed position of housing 100 is also shown in FIG. 5, having lid 101, back wall 103, front wall 104 and side walls 105, 106.

Thus, in conclusion, the ozone generator, the first pump, the second pump, the scavenging means and the control means may be provided in a housing. At the front panel side of the housing there is a lid, which is connected to the housing by a hinge 102. The lid is easy to open and close forming a reversibly sealable hollow chamber when in the closed position. During the treatment of the patient, the lid is open and so it gives access to the front panel, where all required controls may be installed. In a preferred embodiment, the ozone generator, the first pump, the second pump, the scavenging means and the control means are provided in a box-like housing which may be sealingly closed by a lid. When the lid is placed on the box-like housing, a reversibly sealable chamber is formed inside the box-like housing in the space between the inner face of the lid and the portion of the housing which contains the ozone generator, the first pump, the second pump, the scavenging means and the control means. The chamber is sufficiently large to receive e.g., the applicator and any tubing or lines which are used during the treatment of a patient. Thus, after treatment of the patient, the device of the invention may be contaminated and needs to be sterilized.

FIG. 3 thus illustrates the position of the parts wherein the applicator, the tubing and the like may be placed after the treatment of the patient for the purpose of sterilizing the equipment. Accordingly, a tight chamber may be providing as seen in FIG. 4 by closing the lid of the housing 100. Ozone containing gas may be introduced into the housing 100. After the sterilizing step, the housing is opened and the sterilized equipment may be used again.

Thus, it can be seen that, in at least one aspect of one embodiment of the present invention, the various components of the various embodiments disclosed herein may be contaminated and needs to be sterilized subsequent to the treatment of the patient.

For sterilizing purposes, in at least one embodiment, the reversibly sealable chamber is closed and the interior of the chamber being in fluid communication with the ozone generator, whereby the inner wall of the chamber at least partially comprises surfaces of the device exposed to the environment during use of the device for treating a dental tissue.

For this sterilizing purpose, in at least one embodiment, the means for controlling the operation of the ozone generator, the first pump and the second pump, when the reversibly sealable chamber is sealed, may be set so as to introduce ozone into the reversibly sealable chamber over a predetermined period of time. During this period, the reversibly sealable chamber may further contain the applicator, tubing or other contaminated devices.

After the predetermined period of time, any excess ozone contained in the reversibly sealable chamber may be eliminated by either reversing the sealing of the chamber, or by using one or more orifices in the housing provided for eliminating ozone contained in the reversibly sealable chamber after the treatment of surfaces of the device exposed to the environment during use of the device for treating a dental tissue.

Moreover, in at least one embodiment of the present disclosure, the housing may comprise one or more orifices for eliminating ozone contained in the reversibly sealable chamber after the treatment of surfaces of the device exposed to the environment during use of the device for treating a dental tissue.

The device according to the present disclosure may be part of a system comprising a device for treating a dental tissue with a continuous pulsing flow of ozone containing gas, and a plurality of applicators.

In one aspect of at least one embodiment of the present disclosure, the dental tissue is treated with a continuous flow of ozone containing gas and may be used as follows.

Prior to activating the ozone generator the applicator is placed in the patient's mouth so that a treating chamber is formed by the inner surface of the applicator and the hard and soft dental tissue and the gums to be treated. Subsequently, a gas flow may be initiated by activating the first pump and the second pump. Provided that the gas flow is established, the ozone generator may be activated. Accordingly, the flow of gas then will include an amount of ozone to which the dental surface and the gums inside the treating chamber are exposed. The treatment of dental tissue and gums of a patient by applying a continuous pulsing flow of ozone for a period of time may be applied for an adjustable predetermined time in the range of from 1 minute to 60 minutes. During the treatment of the patient, the continuous flow of ozone containing gas may be applied by periodically pulsing changing the flow speed of gas.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A device for treating a dental tissue with a continuous flow of ozone containing gas, comprising:
(a) an ozone generator for generating an ozone containing gas;
(b) a first pump being in fluid flow communication with the ozone generator for generating a flow of ozone containing gas;
(c) an applicator for multiple teeth having a surface suitable for conforming to hard and soft dental tissue of multiple teeth to be treated;
for providing a treatment chamber having at least one inlet orifice being in fluid flow communication with the ozone generator and the first pump and having at least one outlet orifice; and
(d) a second pump being in fluid flow communication with the at least one outlet orifice for removing gas from the treatment chamber, whereby said second pump has a second throughput and the first pump has a first throughput whereby the ratio of the second throughput of the second pump to the first throughput of the first pump is at least 1.5:1.

2. The device according to claim 1, wherein the ozone containing gas generated by the ozone generator has an ozone concentration of from 50 to 20000 ppm.

3. The device according to claim 1, wherein the first pump has a pumping speed in the range of from 1 to 10 l/min.

4. The device according to claim 3, wherein the second pump has a pumping speed in the range of from over 1.5 to 15 l/min.

5. The device according to claim 1, further comprising: (e) a moisture trapping means downstream from the outlet orifice of the applicator and in fluid communication therewith and upstream from the second pump and in fluid communication therewith.

6. The device according to claim 1, further comprising an ozone scavenging means downstream from the second pump.

7. The device according to claim 1, further comprising a prefabricated applicator.

8. The device according to claim 1, said device including one or more control means for periodically changing the ratio of the second throughput of the second pump to the first throughput of the first pump by interrupting the second pump so that the speed and pressure of the continuous flow of ozone containing gas periodically changes in the treatment chamber, and
further comprising said one or more control means controlling the throughput at least one of the first pump and second pump.

9. The device according to claim 7, wherein the one or more control means periodically reduces the throughput followed by an increase of the throughout of the pump.

10. The device according to claim 8, wherein the reduction and increase of the throughput occurs with a frequency of from 1 to 200 cycles per minute.

11. The device according to claim 1, said device having surfaces exposed to the environment, wherein the ozone generator, the first pump and the second pump are provided in a housing and whereby the housing further contains a reversibly sealable chamber being in fluid communication with the ozone generator, whereby said chamber has an inner wall, the inner wall of said chamber at least partially comprised of surfaces of the device exposed to the environment during use of the device for treating a dental tissue.

12. The device according to claim 11, comprising a means for controlling the operation of the ozone generator, the first pump and the second pump, when the reversibly sealable chamber is sealed.
